(19) United States
(12) Patent Application Publication
(10) Pub. No.: US 2005/0111172 A1
(43) Pub. Date: May 26, 2005

(54) HANDHELD ELECTRONIC DEVICE

(76) Inventor: John C. Wang, Tao Yuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,897

(22) Filed: Jun. 4, 2004

(30) Foreign Application Priority Data
Nov. 3, 2003 (TW) 92219504

(51) Int. Cl. G06F 1/16

(52) U.S. Cl. 361/680; 361/681; 361/683; 341/22; 248/918

(57) ABSTRACT

A handheld electronic device has a body (110) and a sliding member (120) wherein the body is pivotably mounted on the sliding member by a pivot axle (102). The body is provided with a display (510) thereon, and the sliding member is provided a keyboard (520) thereon. When the sliding member is lengthwise aligned with the body, the keyboard is hidden below the body. When the sliding member is rotated relative to the body to reach a position wherein the sliding member is at an orientation perpendicular to that of the body, the keyboard is exposed and has two end portions located outside of lateral sides of the body, respectively.

### CROSS REFERENCE TO RELATED APPLICATIONS

This application claims the priority benefit of Taiwan application serial no. 92219504, filed Nov. 3, 2003.

### BACKGROUND OF INVENTION

1. Field of the Invention

This invention generally relates to a handheld electronic device, and more particularly to a handheld electronic device having a body and a sliding member pivotably connected together, wherein the body is provided with a display and the sliding member is provided with a keyboard. The sliding member is pivotable relative to the body between closed and opened positions. At the closed position, the sliding member is hidden below the body, and at the opened position, the sliding member is exposed and extends across a part of the body.

2. Description of Related Art

A handheld electronic device is a miniature, portable electronic device, such as a mobile phone, a handheld PC, or a personal digital assistant (PDA). Since a handheld electronic device applies to wireless communication and Internet fields, mobile communication processing is thus provided for convenience and efficiency, and becomes one of the most popular high-tech electronic products. However, since a handheld device only has a palm size, wherein a display of the device occupies most of the area, area available for a keyboard thereof is small; the keyboard thus cannot be provided with a large number of keys, which is disadvantageous when a user needs to input text message into the handheld device. To solve this problem, conventional art introduces a number of solutions as described below.

FIGS. 1˜3 illustrate three conventional handheld devices each having a keyboard suitable for entering text messages to the respective handheld device. Referring to FIG. 1, a mobile phone 10 is shown. The mobile phone 10 has a display 12 and a keyboard 14 below the display 12. The area available for the keyboard 14 only allows a few keys to be provided to the keyboard 14, i.e., ten number keys and several function keys (including an on/off key). Such a keyboard 14 is inconvenient for a user to input text messages to the mobile phone 10. Thus, a large external keyboard 16 is provided in the market to come up with input inconvenience to the mobile phone 10. Yet the large external keyboard 16 occupies too much space, which is not valid for portable purpose. Furthermore, to simultaneously carry the mobile phone 10 and the external keyboard 16 is not convenient.

Referring to FIG. 2, a wireless e-mail device 20 is shown. The device 20 is designed widened laterally, whereby it can have a wider display 22 and a larger area below the display 22 to receive a keyboard 24. The keyboard 24 can accommodate more keys to construct a QWERTY keyboard so that a user of the device 20 can easily input a text message. Although the handheld device 20 of FIG. 2 can solve the inconvenience of the mobile phone 10 of FIG. 1, which needs an external keyboard 16, the increase of the width of the device 20 causes the device 20 to be too bulky, which is opposite to the compact trend of the handheld device. Furthermore, the increase of width brings inconvenience for the user to hold the device 20 by his (her) palm.

Furthermore, refer to FIG. 3, where a PDA 30 is illustrated. The PDA 30 has a display 32 and a couple of function keys 34 disposed below the display 32. Although the PDA 30 is equipped with a stylus (not shown) which can be used for text message input, since stylus input is not as quickly as keyboard input, an external QWERTY keyboard 36 is provided for the PDA 30 so that a user can use the keyboard 36 to input the text message. Like the mobile phone 10 of FIG. 1, it is troublesome for the user to simultaneously carry two apparatuses (i.e., PDA 30 and keyboard 36).

Another type of conventional handheld device is disclosed in U.S. Design Pat. No. D421983, entitled “Cellular Telephone with Pivoted Keyboard”, which has a keyboard pivotally connected to a back of a body of the cellular telephone. The pivot axle is located at a corner area of the keyboard, so that the keyboard is pivoted to expose a plurality of keys at a lateral side of the mobile phone for data input. Moreover, referring to FIG. 4, another cellular telephone 40 with a pivoted keyboard 44 is disclosed. The keyboard 44 is accommodated within a recess 42 of the body 40 and can be pivoted out of the recess 42. The keyboard 44 has a pivot axle located at a corner area thereof and connecting with a body of the telephone 40, so that the keyboard 44 can be rotated out of the recess 42 to expose a plurality of keys 46 at a lateral side of the telephone 40 for data input.

It is noted that the foregoing pivoted keyboard 44 is shaped as elongated thin slice, and the pivot axle is also disposed at a corner area of the keyboard 44. If not being enhanced sturdiness of the body of the keyboard 44, the pivot axle does not manage to uphold the weight of the body 40 of the mobile phone, whereas one hand of the user holds the bottom of the body 40, and another hand serves to input data. Therefore, ergonomics is not complied with the operation, and slow data input with single hand is caused. Furthermore, for such handheld electronic devices of U.S. Design Pat. No. D421983 and FIG. 4, as one hand is needed to hold the body of the device, the user cannot use both thumbs to input the text messages, which is found as the most efficiently key—in method for the small keyboards. In addition, since the keyboards are entirely located at a lateral side of the bodies of the devices, it is not convenient for the user to watch the displays while keying the text messages to check out the correctness of his (her) typing.

### SUMMARY OF INVENTION

An object of the present invention is to provide a handheld electronic device having a pivotal structure pivotably connecting a sliding member and a body of the handheld electronic device together wherein the sliding member is provided with a keyboard thereon. The pivotal structure is so located that after the sliding member is rotated related to the body, the sliding member extends across a part of the body to cause the device to have an inverted “T” configuration, whereby a user of the device can easily use his (her) two thumbs to type the keyboard so that a text message can be quickly entered into the device.

Another object of the present invention is to provide a handheld electronic device having a pivotal structure pivotably connecting a body and a sliding member of the handheld electronic device together. The body has a display thereon and the sliding member has a keyboard thereon. The pivotable structure is so located that after the sliding member is rotated related to the body, the sliding member extends across the body and the body is located at a median of a top of the sliding member whereby the a user can readily type with the keyboard while look at the display.

In order to comply with the foregoing purposes, the present invention provides a handheld electronic device having a body and a sliding member and a pivotal structure, wherein the pivotal structure pivotably connects the sliding member and the body together. In addition, the body possesses a first geometry center, and the sliding member possesses a second geometry center, and the first geometry center and the second geometry center are coincidental when the sliding member is entirely hidden below the body (i.e. closed position). The pivotal structure includes a pivot axle, which has a first pivot joint and a second pivot joint, where the first pivot joint is disposed on a bottom surface of the body, and the second pivot is disposed on a top surface of the sliding member. The pivot axle is not disposed at the second geometry center or the first geometry center, and at the closed position an included angle between a connecting line from the pivot axle to the second geometry center or the first geometry center and a geometrical center line of the device is 45 degrees. When the sliding member rotates by 90 degrees with respect to the body to an opened position, the first geometric center of the body and the second geometric center of the sliding member are separated and aligned on the geometrical center line of the device so that the sliding member has two ends located laterally out of two lateral sides of the body, respectively.

In a further aspect of the present application, a handheld electronic device is provided, including a body and a sliding member. The body has a bottom surface, the sliding member has a pivotal structure, and the sliding member is pivotally connected to the bottom surface of the body. The body has a longitudinal central line, which is aligned with a longitudinal central line of the sliding member when the sliding member is located at a closed position. After the sliding member is rotated relative to the body for 180 degrees from the closed position to an opened position, the longitudinal central lines are offset from each other a distance, and upper and lower ends of the sliding member are located out of upper and lower ends of the body, respectively.

According to the further aspect of the present invention, the body has a display for displaying data. Moreover, the sliding member has a Qwerty keyboard for text data input. At the closed position, the keyboard has some keys exposed below the display, for functioning as a mobile phone keypad. Accordingly, at the closed position, the handheld electronic device of the present application can be used as a mobile phone. At the opened position, keys which are hidden below the body when the sliding member is at the closed position, are exposed so that a user of the handheld electronic device can easily type a text message to the device by using the Qwerty keyboard. At the opened position, the handheld electronic device of the present invention can be used as a wireless e-mail machine.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIGS. 1 to 3 are diagrams illustrating three mobile phones and keyboard assemblies thereof according to conventional schemes.

FIG. 4 is a diagram illustrating a mobile phone with a pivoted keyboard according to prior art.

FIGS. 5A˜5B are top view diagrams illustrating a handheld electronic device according to a first preferred embodiment of the present invention at different operating positions.

FIGS. 6A˜6B are side view diagrams of FIGS. 5A and 5B, respectively.

FIGS. 7A˜7B are top view diagrams illustrating a handheld electronic device according to a second preferred embodiment of the present invention at different operating positions.

FIGS. 8A˜8C are top view diagrams of a handheld electronic device according to a third preferred embodiment of the present invention at different operating positions.

FIGS. 9A˜9C are top view diagrams illustrating a handheld electronic device according to a fourth preferred embodiment of the present invention at different operating positions.

FIGS. 10A˜10B are top view diagrams illustrating a handheld electronic device according to a fifth preferred embodiment of the present invention at different operating positions.

FIGS. 11A˜11B are side view diagrams of FIGS. 10A and 10B, respectively.

FIGS. 12A˜12B are top view diagrams illustrating a handheld electronic device according to a sixth preferred embodiment of the present invention at different operating positions.

FIGS. 13A, 13B and 13C are top view diagrams illustrating a handheld electronic device according to a seventh preferred embodiment of the present invention at different operating positions.

FIGS. 14A and 14B are diagrams illustrating a practical application of the handheld electronic device of the first preferred embodiment of the present invention as a PDA.

FIGS. 15A, 15B and 15C are diagrams of a body, a sliding member and a combination of the body and the sliding member of a handheld electronic device according to an eighth preferred embodiment of the present invention.

FIGS. 16A, 16B and 16C are diagrams of a body, a sliding member and a combination of the body and the sliding member of a handheld electronic device according to a ninth preferred embodiment of the present invention.

FIG. 16D is a side view diagram illustrating a variation of the handheld electronic device of the ninth embodiment of the present invention.

FIGS. 17A, 17B and 17C are diagrams of a handheld electronic device according to a tenth embodiment of the present invention at different operating positions.

FIGS. 18A and 18B are diagrams illustrating a handheld electronic device according to an eleventh preferred embodiment of the present invention at different operating positions.

FIGS. 19A and 19B are diagrams illustrating a practical application of the handheld device of the fifth embodiment of FIGS. 10A˜11B as a wireless PDA phone.

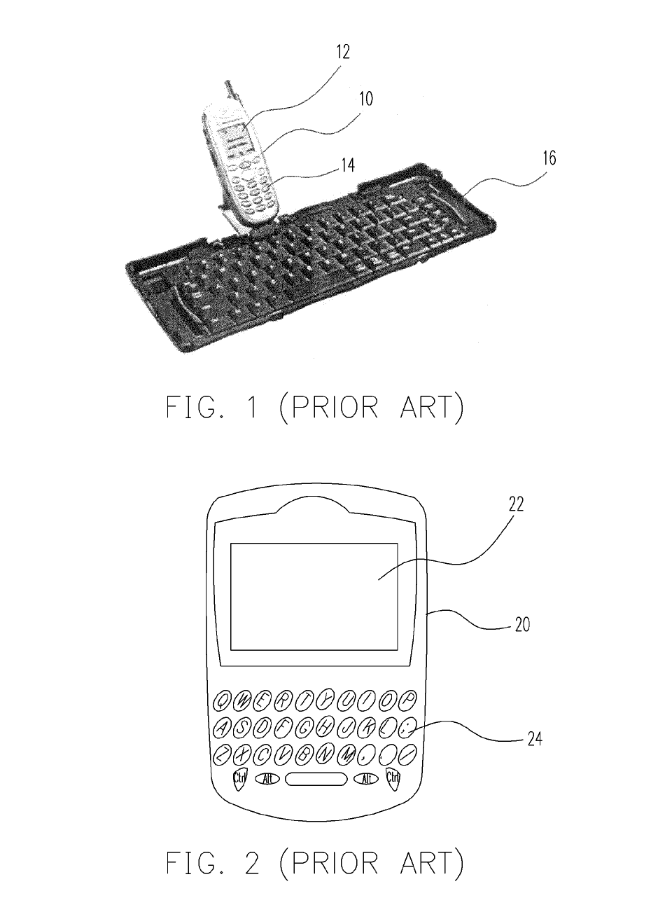

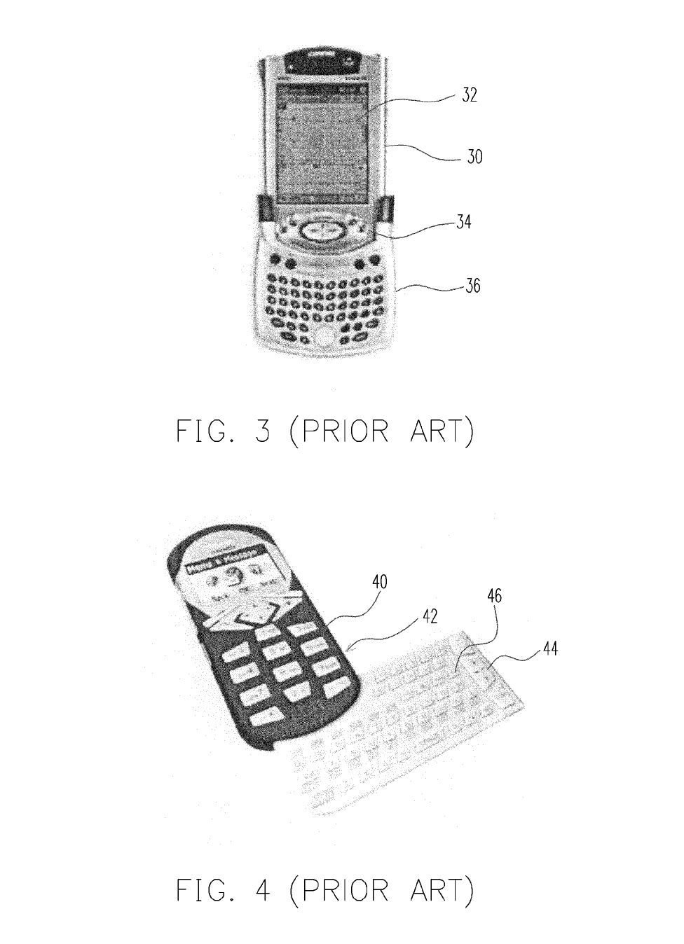

### DETAILED DESCRIPTION

### First Preferred Embodiment

Referring to FIGS. 5A˜6B, a handheld electronic device in accordance with a first embodiment of the present invention is shown.

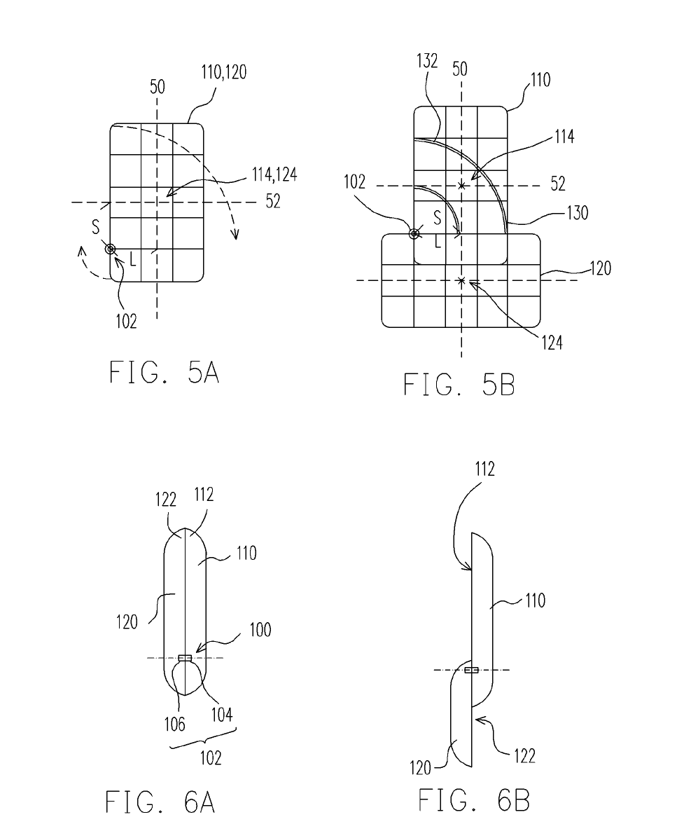

Please refer to FIG. 5A and FIG. 6A firstly. A pivotal structure 100 is disposed between a body 110 and a sliding member 120, a bottom surface 112 of the body 110 is against a top surface 122 of the sliding member 120, and the sliding member 120 is pivotally connected to the body 110 through the pivotal structure 100. In this preferred embodiment, the body 110 and the sliding member 120 are similar in size, curvature, corner radian, and thickness, so that the body 110 and the sliding member 120 are consistent in profile, whereas the profile is categorized into elongated shape. However other shapes of the body 110 or the sliding member 120 are within the scope of this present invention, for example, regular polygon (equivalent triangle, equivalent tetragon, equivalent pentagon, etc.), or circle and ellipse, also fall within the scope of the present invention. In this preferred embodiment, an elongated shape of the body 110 and the sliding member 120 are exemplary for following descriptions of various constructions of the present invention.

The pivotal structure 100 includes a pivot axle 102, which has a first pivot joint 104 and a second pivot joint 106. The first pivot joint 104 is disposed on the bottom surface 112 of the body 110 and the second pivot joint 106 is disposed in the top surface 122 of the sliding member 120, so that the body 110 and the sliding member 120 can rotate relative to each other. Moreover, the body 110 and the sliding member 120 have a first geometric center 114 and a second geometric center 124 respectively, which are imposed and aligned along a vertical geometric center line 50 of the handheld electronic device when the handheld electronic device is at a deployed (opened) position as shown in FIG. 5B. Furthermore, the centers 114, 124 are coincidental at an intersection of the vertical central line 50 and a horizontal central line 52 when the devise is at a folded (closed) position as shown in FIG. 5A. The intersection of the two lines 50 and 52 is defined as a geometric center of the electronic device. The pivot axle 102 is not disposed on the geometric center of the electronic device, and the pivot axle 102 and the two geometric center lines 50 and 52 are distanced by L and S, respectively, where L=S. Since the pivot axle 102 is not located at the geometric center of the handheld electronic device, when the sliding member 120 rotates with respect to body 110 about the pivot axle 102 (e.g. clockwise rotation), the geometric center 124 of the sliding member 120 varies its position corresponding to the rotational angle. When the sliding member 120 rotates by 90 degrees, the geometric center 124 of the sliding member 120 is aligned with the geometric center 114 of the body 110 along the vertical geometric center line 50 to form a symmetrical construction, which is shown in FIG. 5B. As shown in FIG. 5B, the sliding member 120 is located in a horizontal orientation at a lower portion of the body 110, with two ends of the sliding member 120 protruding out of two lateral sides of the body 110 equidistantly.

Still refer to FIG. 5B. It is noted that when the sliding member 120 rotates by 90 degrees, the lengthwise sides of which are horizontally fixed to the lower portion of the body 110, and perpendicular to the lengthwise sides of the body 110, so that the ends of the sliding member 120 are respectively protruded out of the two lengthwise (lateral) sides of the body 110. Different from the prior art, the pivotal structure 110 in accordance with the present invention makes the geometric center 124 of the sliding member 120 located at a point of the vertical geometric center line 50 of the handheld electronic device after the sliding member 120 is rotated by 90 degrees to the opened position. Thus, the handheld electronic device in accordance with the present invention can achieve the feature that the ends of the sliding member 120 symmetrically protrude out of the two lengthwise sides of the body 110, respectively, after the sliding member 120 is rotated 90 degrees relative to the body 110. The geometry of the handheld electronic device in accordance with the present invention after the sliding member 120 is rotated relative to the body 110 by 90 degrees is decided by the location of the pivot axle 102 which can vary in accordance with actual requirement, and an aspect ratio of the handheld electronic device. Different geometry of the handheld electronic device due to different locations of the pivot axle 102 and different aspect ratios of the handheld electronic device are disclosed in the following descriptions. In the following descriptions, the body 110 and the sliding member 120 have the same size. In the first embodiment, in order to facilitate a smooth rotation of the sliding member 120 relative to the body 110, two arched tracks 132 are defined in the bottom surface 112 of the body 110 and two engaging members 130 are formed on the top surface 122 of the sliding member 120 movably fitting in the tracks 132, respectively.

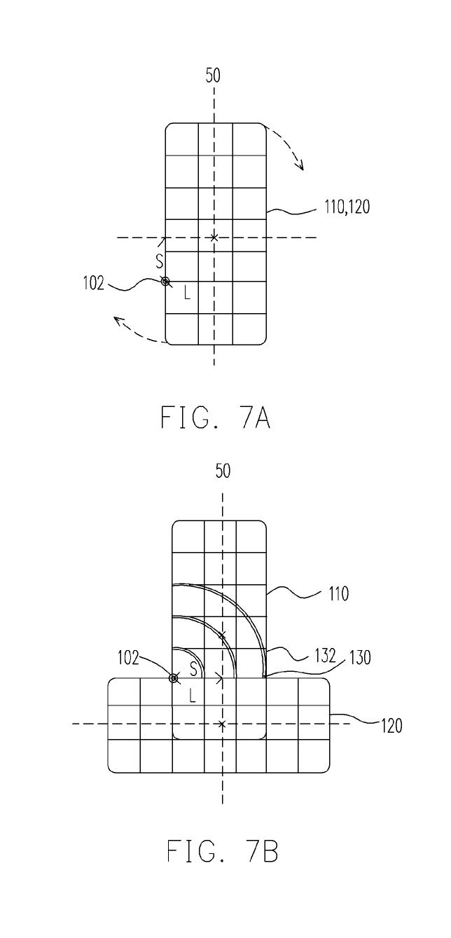

Referring to FIGS. 7A and 7B, a handheld electronic device in accordance with a second embodiment of the present invention is shown. The device has an increased length in comparison with that of the first embodiment, i.e., the aspect ratio of the handheld electronic device in accordance with the first embodiment being about 5:3, whereas the aspect ratio of the handheld electronic device in accordance with the second embodiment is about 7:3. It is noted that however the two embodiments share a common feature that the distance L from the pivot axle 102 to the vertical geometric center line 50 of the handheld electronic device is equal to the distance S from the pivot axle 102 to the horizontal geometric center line 52.

In this embodiment, since the handheld electronic device has a large aspect ration (length/width), after the sliding member 120 is rotated to a horizontal orientation, the ends of the sliding member 120 protruding out of the lateral sides of the body 110 have a larger distance than that in the first embodiment.

Furthermore, in this embodiment, there are three guiding tracks 132 defined in the bottom surface of the body 110 and three engaging members 130 formed on the top surface of the sliding member 120 for movably engaging with the guiding tracks 132.

### The Third And Fourth Preferred Embodiments

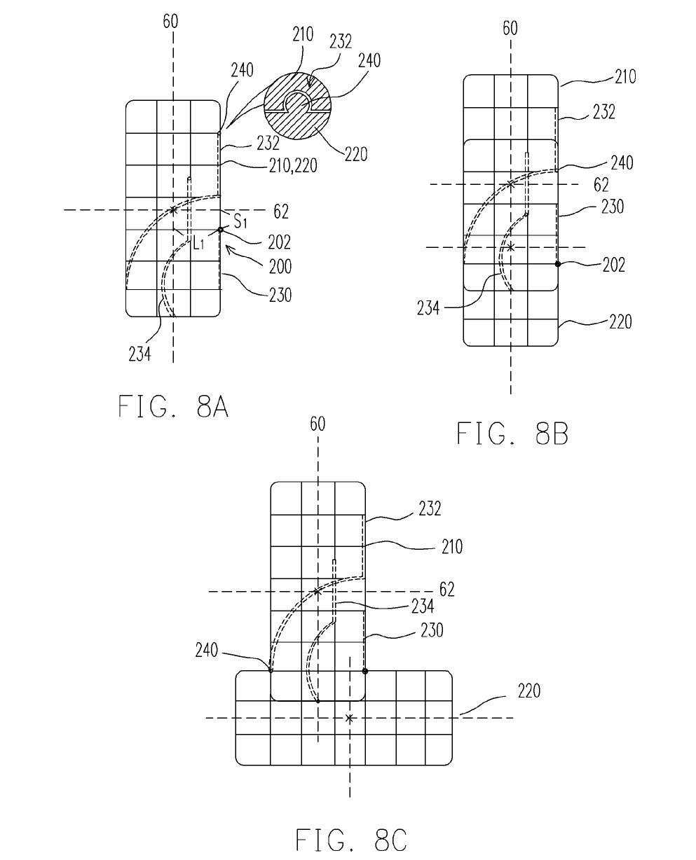

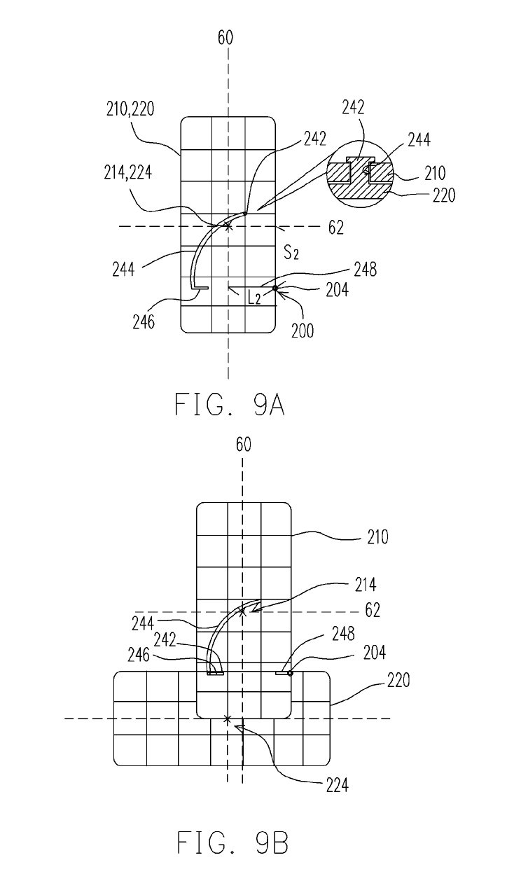

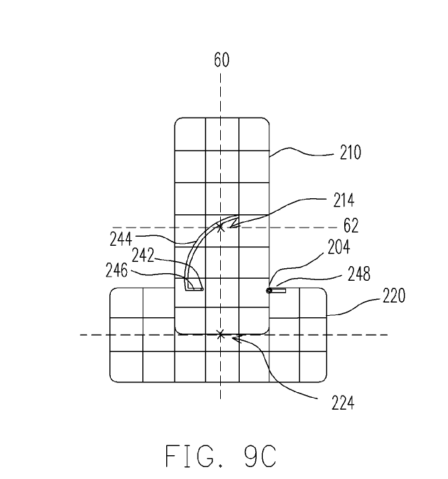

FIGS. 8A˜8C illustrate a handheld electronic device according to a third preferred embodiment of this present invention, whereas FIGS. 9A˜9C illustrate a handheld electronic device according to a fourth preferred embodiment of this present invention. The handheld electronic devices of the third and fourth embodiments possess the same size; yet the pivot axles of the two embodiments are located differently and the guiding structures thereof are also different from each other so that the two embodiments have different geometry after the sliding members are extended from the bodies of the handheld electronic devices. In FIG. 8A, the distance L1 between a pivot axle 202 of a pivotal structure 200 and a vertical geometric center line 60 is larger than the distance S1 between the pivot axle 202 and a horizontal geometric center line 62. In FIG. 9A, a distance L2 between the pivot axle 204 of the pivotal structure 200 and the vertical geometric center line 60 is smaller than the distance S2 between the pivot axle 204 and the horizontal geometric center line 62.

Furthermore, a guiding structure is disposed on the bottom surface of the body 210 and the top surface of the sliding member 220 in the third preferred embodiment. The guiding structure includes a plurality of guiding tracks 230,232,234, which are recessed in the bottom surface of the body 210. The guiding track 230 has a configuration of a straight line, while the other two tracks 232, 234 each have a straight section and an arched section. The guiding track 230 has a length, which is substantially the same as that of straight sections of the guiding tracks 232, 234. Referring to FIG. 8A, an enlarged cross-sectional diagram for a part of the handheld electronic device is shown in a circle. An engaging member 240 is formed on a top surface of the sliding member 220 movably fitting into the guiding track 232 of the body 210. In FIGS. 8A˜8B, the pivot axle 202 is received in the guiding track 230. To extend the sliding member 220 from the body 210, firstly the sliding member 220 is motivated to move downwardly relative to the body 210 so that the pivot axle 202 and the engaging members 240 are moved from upper ends of the guiding track 230 and the straight sections of the guiding tracks 232, 234 to reach bottom ends thereof as shown in FIG. 8B. At this position, a lower end of the sliding member 220 protrudes beyond a lower end of the body 210. Thereafter, the sliding member 220 is rotated relative to the body 210 to reach the position as shown in FIG. 8C. The sliding member 220 is rotated by 90 degrees counterclockwise, and the engaging members 240 move from upper ends to lower ends of the arched sections of the sliding rail 232, 234, so that two ends of the sliding member 220 protrude out of two lateral sides of the body 210. In this embodiment, the distances of the ends of the sliding member 220 protruding out of the body 210 are not equal to each other, i.e., the right end having a longer length protruding out of the lateral side of the body 220 than the left end, as shown in FIG. 8C.

Please refer to FIG. 9A, where an enlarged cross-sectional diagram of a part of the handheld electronic device is shown in a circle. In this embodiment, the handheld electronic device has a pivotal structure 200 having a pivot axle 204, a vertical central line 60 and a horizontal central line 62. The body 220 has a center 214. The sliding member 220 has a center 224. The body 220 has a guiding track 244, which is a slit defined through the body 220. The sliding member 220 has a guiding track 248 defined therein. The engaging member 242 extends through the corresponding guiding track 244. The guiding track 244 has an arched section and a straight section 246 extending horizontally at a lower end of the arched section. The guiding track 248 is straight and horizontally extended, and has a length which is substantially the same as that of the straight section 246 of the guiding track 244. Moreover, in FIGS. 9A and 9B, the pivot axle 204 is received in the guiding track 248. In operation to extend the sliding member 220 from the body 210, first the sliding member 220 is rotated relative to the body 210 about the pivot axle 204 to reach a position in which the engaging member 242 reaches the lower end of the arched section of the guiding track 244. Then the sliding member 220 is moved rightwards to reach the position as shown in FIG. 9C.

### The Fifth And Sixth Preferred Embodiment

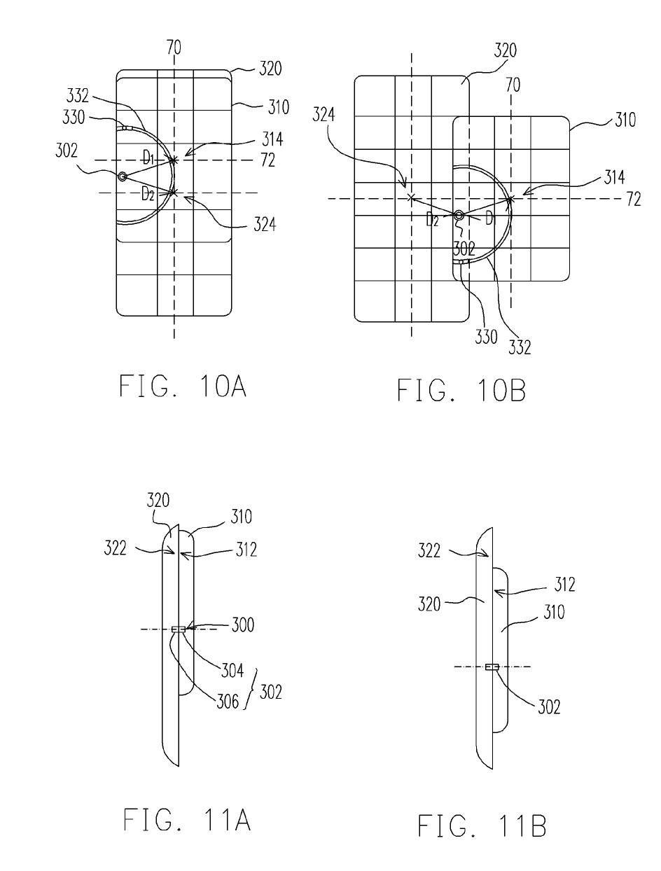

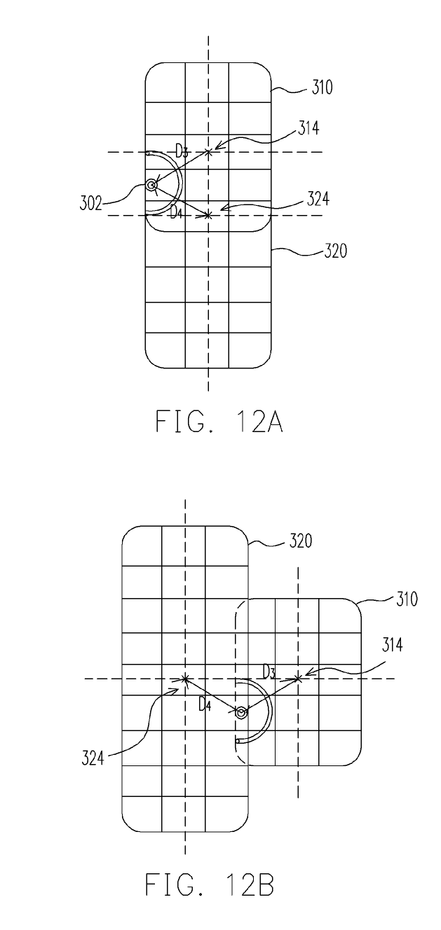

FIGS. 10A˜10B illustrate top view diagrams of a handheld electronic device according to a fifth preferred embodiment of this present invention. FIGS. 11A˜11B illustrate side view diagrams of the handheld electronic device of FIG. 10A and FIG. 10B respectively. Moreover, FIGS. 12A and 12B illustrate top view diagrams of a handheld electronic device according to a sixth preferred embodiment of the present invention.

Referring to FIGS. 10A and 11A firstly. The handheld electronic device has a pivotal structure 300 disposed between a body 310 and a sliding member 320, where a top surface 322 of the sliding member 320 is pivoted to the bottom surface 312 of the body 310 via the pivotal structure 300.

The pivotal structure 300 includes a pivot axle 302, which has a first pivot joint 304 and a second pivot joint 306. The first pivot joint 304 is disposed in the bottom surface 312 of the body 310, and the second pivot joint 306 is disposed in the top surface 322 of the sliding member 320, so that the body 310 and the sliding member 320 can rotate relative to each other. Moreover, the body 310 and the sliding member 320 respectively have a first geometric center 314 and a second geometric center 324, which are aligned along a vertical geometric center line 70 of the handheld electronic device when the sliding member 310 is not extended from the body 320 as shown in FIG. 10A. The geometric centers 314,324 are spaced from each other a distance. The first and second geometric centers 314 and 324 are distanced to the pivot axle 302 by D1 and D2 respectively, where D1=D2. Since the pivot axle 302 is not located at the geometric center 324 of the sliding member 320, when the sliding member 320 rotates about the pivot axle 302 for 180 degrees clockwise, the position of the geometric center 324 of the sliding member 320 is changed to be at a left side of the geometric center 314 of the body 310 and aligned therewith along a horizontal central line 72. The sliding member 320 is moved from an unfolded (closed) position of FIG. 10A to a deployed (opened) position of FIG. 10B, wherein in FIG. 10A, the sliding member 320 is located just below the body 310 and in FIG. 10B the sliding member 320 is located neighboring to a left side of the body 310. In FIG. 10B, top and lower ends of the sliding member 320 are located beyond upper and lower ends of the body 310, respectively.

Refer to FIGS. 10B and 11B herein. It is noted that as the sliding member 320 rotates by 180 degrees, the lengthwise sides of the sliding member 320 are substantially parallel to the lengthwise sides of the body 310, and the two ends of the sliding member 320 are protruded symmetrically beyond the two ends of the body 310. A semicircular track 332 is defined in the bottom surface 312 of the body 310 and an engaging member 330 is formed on the top surface 322 of the body 320 and movably engages in the track 332. At the unfolded position of FIG. 10A, the engaging member 330 engages in an upper end of the track 332. During the rotation of the sliding member 320, the engaging member 302 moves along the track 332. And at the deployed position of FIG. 10B, the engaging member 330 reaches a lower end of the track 332. By the guiding means consisting of the guiding track 332 and the engaging member 330, the sliding member 320 can have a reliable and stable rotation relative to the body 310.

The handheld electronic device in accordance with the sixth embodiment as shown in FIGS. 12A and 12B are substantially the same as the fifth embodiment, except that the sixth embodiment has a longer sliding member 320 so that after the sliding member 320 is rotated 180 degrees from the position of FIG. 12A to reach the position of FIG. 12B, a distance of the upper and lower ends of the sliding member 320 protruding beyond the upper and lower ends of the body 310 is larger than that of the fifth embodiment. In the sixth embodiment, a distance D3 between the pivotal axle 302 and a geometry center 314 of the body 310 is equal to a distance D4 between the pivotal axle 302 and a geometry center D4 of the sliding member 320.

### The Seventh Preferred Embodiment

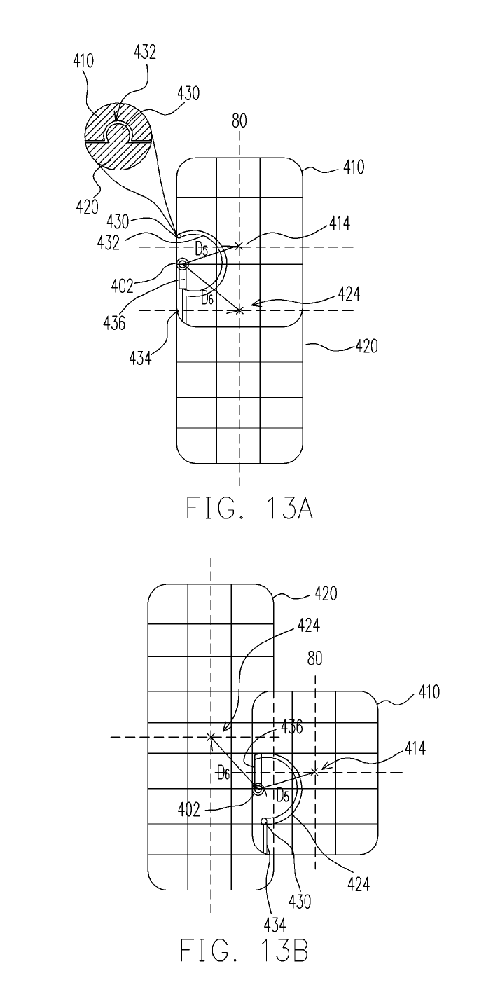

Referring to FIGS. 13A, 13B, and 13C, top view diagrams of a handheld electronic device according to a seventh preferred embodiment of the present invention are illustrated herein. A distance D5 between a pivot axle 402 and a geometric center 414 of a body 410 of the handheld electronic device is smaller than a distance D6 between the axle 402 and a geometric center 424 of a sliding member 420 of the handheld electronic device. When the sliding member 420 is rotated by 180 degrees, the geometric center 424 of the sliding member 420 moves from a first position in which the two centers 414, 424 align with each other along a vertical central line 80 of the device (FIG. 13A) to a second position in which the center 424 is moved to a left side of the center 414 (FIG. 13B). In this preferred embodiment, a guiding structure is provided to facilitate the movement of the sliding member 420 relative to the body 410. The guiding structure includes a plurality of sliding tracks 432, 434, and 436, where the sliding track 436 is defined through the sliding member 420 and the sliding tracks 432 and 434 are defined in a bottom surface of the body 410. The tracks 434 and 436 are vertically straight, while the sliding track 432 has a configuration of a semicircle. The track 434 communicates with a lower end of the track 432. The sliding member 420 is further provided with an engaging member 430 movably engaging in an upper end of the guiding track 432 at the position of FIG. 13A. After the sliding member 420 is rotated 180 degrees relative to the body 410 to reach the position of FIG. 13B, the engaging member 430 moves along the sliding track 432 to reach a lower end of the sliding track 432. Meanwhile, the sliding track 436 which is originally located below the pivotal structure 400 as shown in FIG. 13A is located above the pivotal structure 400, as shown in FIG. 13B. The engaging member 430 movably engages in the guiding track 432 in the bottom surface of the body 410. In FIGS. 13A and 13B, the pivot axle 420 is fixed, and when the sliding member 420 rotates by 180 degrees corresponding to the body 410, the engaging member 430 moves from the upper end of the semicircular sliding track 432 to the lower end thereof. The two lengthwise ends of the sliding member 420 protrude out of the lengthwise ends of the body 410, respectively, with different distances. It is noted that the sliding track 436 is opened in the siding member 420. The sliding track 434 is defined in the bottom face of the body 410 and connects and vertically extends from the lower end of the sliding track 432. As the sliding member 420 rotates relative to the body 410, the sliding track 436 rotates accordingly. The sliding track 436 and the sliding track 434 are parallel to each other, and a center of the semicircular sliding track 432 is located at the pivot axle 402. After the sliding member reaches the position of FIG. 13B, the sliding member 420 is further moved vertically downwards to reach the position of FIG. 13C, in which the engaging member 430 moves from the upper end of the sliding track 434 to the lower end thereof, and the pivot axle 420 also moves from the lower end the sliding track 436 to the upper end thereof; at this position, the upper and lower ends the sling member 420 protrude top and lower ends of the body 410 with equal distance.

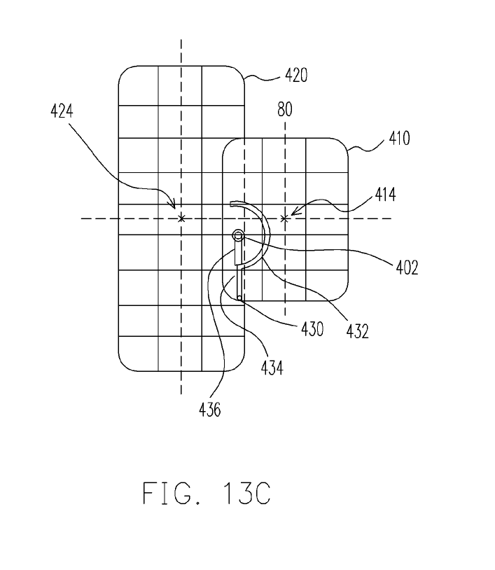

Referring to FIGS. 14A and 14B, the first embodiment of the present invention of FIGS. 5A-5D is practiced as a PDA, in which an LCD display 140 is mounted in the body 110 and five operation buttons 144 are positioned in the body 110 below the LCD display 140. The sliding member 120 is provided with a keyboard 142, which preferably is Qwerty keyboard. The pivot axle 102 for pivotably connecting the sliding member 120 and body 110 together is provided at a left, lower corner of the sliding member 120 and the body 110. The sliding member 120 and the body 110 have the same size and shape; thus, when the body 110 is mounted on the sliding member 120 and lengthwise aligned therewith, the sliding member 120 is totally hidden below the body 110. After the sliding member 120 rotates relative to the body 110 about the pivot axle 102 for 90 degrees from the position of FIG. 14A to reach the position of FIG. 14B, the sliding member 120 is located across a lower end of the body 110 so that the Qwerty keyboard 142 is located below the lower end of the body 110 and has two lateral portions located outside the lateral sides of the body 110, respectively. For such configuration when the sliding member 120 is unfolded from the body 110, a person can easily uses his (her) to two palms to hold two lateral ends of the sliding member 120 and his (her) two thumbs to enter the required typing on the Qwerty keyboard 142. Furthermore, since the display 140 is located at a median of a top of the Qwerty keyboard 142, when the user types the text message, he (she) can look at the display 140 to check the correctness of the typed text without any inconvenience.

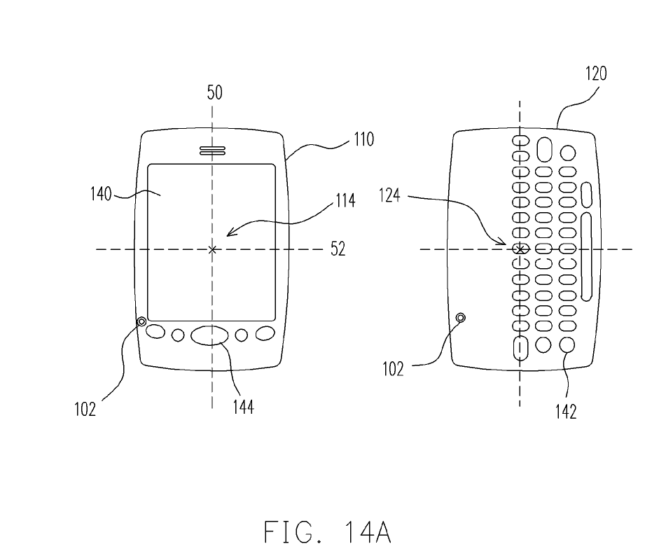

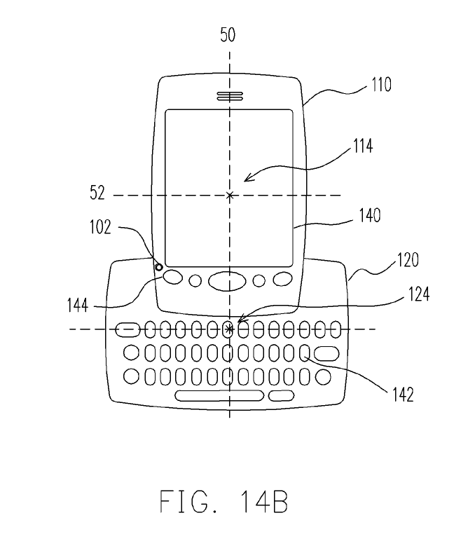

Referring to FIGS. 15A, 15B and 15C, a handheld device in accordance with an eighth embodiment of the present invention is shown. In this embodiment, the sliding member 522 is configured having a length smaller than that of the body 512. In addition to the Qwerty keyboard 528, the sliding member 522 is further provided with a navigator button 527 and two special function keys 525 above the Qwerty keyboard 528. The body 512 is provided with an LCD display 513 and a mobile phone key pad 508 below the LCD display 513. A pivot axle 502 is provided at a lower, left corner of the body 512 and sliding member 522. When the body 512 is lengthwise alignedly mounted on the sliding member 522, the lower end of the sliding member 522 is aligned with the lower end of the body 512, and the upper end of the sliding member 522 is located within a bottom recess 518 of the body 512, as shown in FIG. 15B. After the sliding member 522 is rotated relative to the body 512 to the position of FIG. 15C, the Qwerty keyboard 528 is located relative to the body 512 in a manner the same as that of the embodiment of FIG. 14B; however, the navigator button 527 is located beside a right side of the body 512, and the special function keys 525 are located beside a left side of the body 512. In this embodiment, at the closed position, the handheld electronic device is used as a mobile phone, and at the opened position, as a e-mail machine.

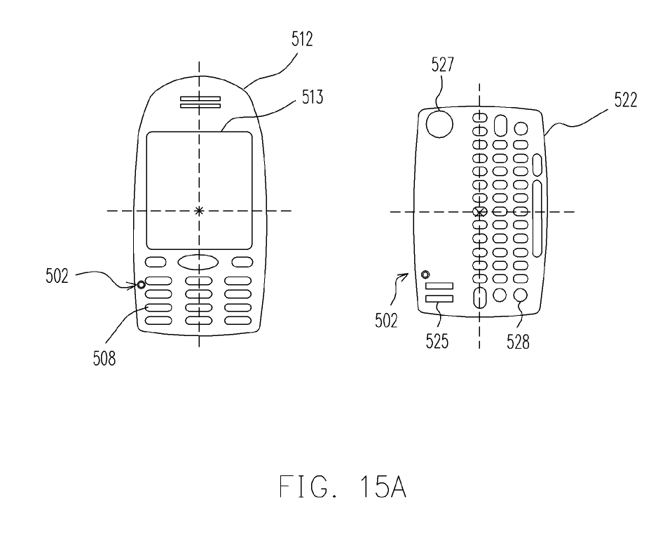

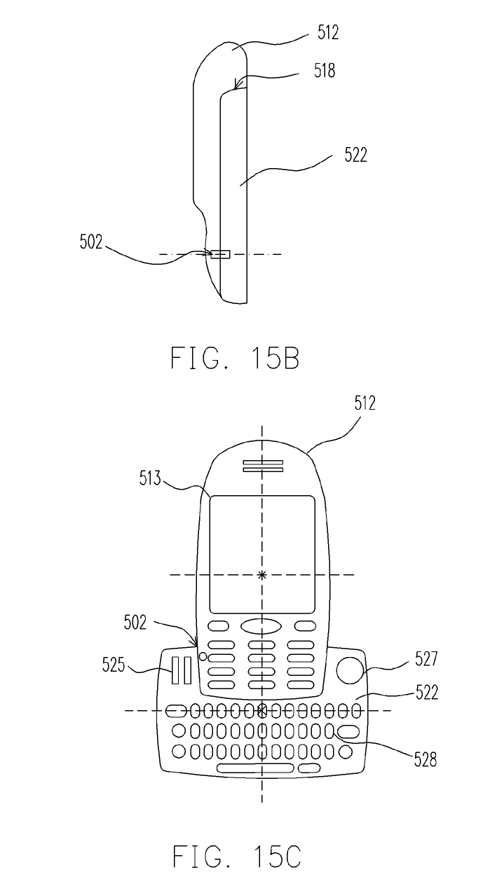

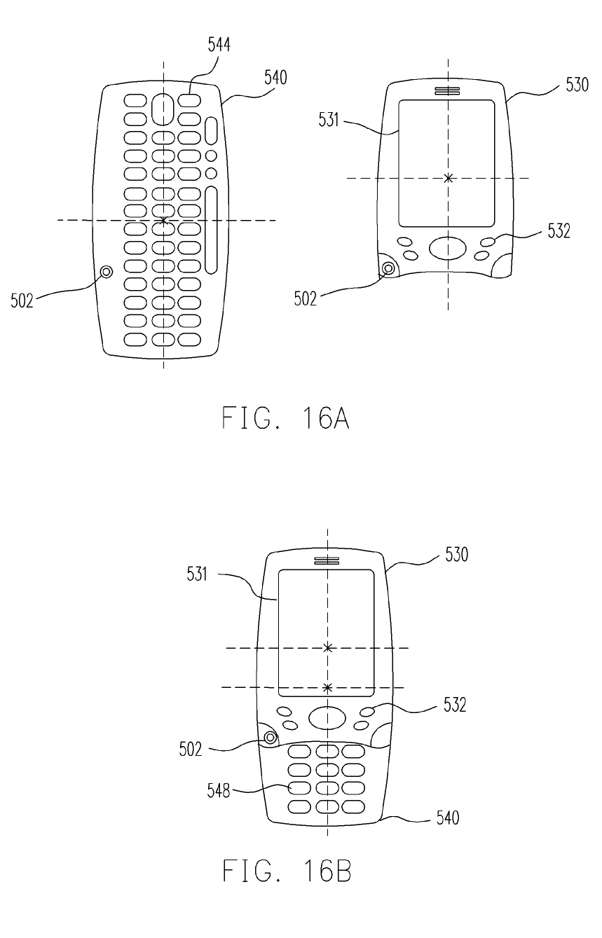

Further referring to FIGS. 16A, 16B, and 16C, a handheld electronic device in accordance with a ninth embodiment of the present invention is shown. In this embodiment, the body 530 has a length smaller than that of the sliding member 540. The body 530 has a display 531 thereon and several operating buttons 532 below the display 531. The sliding member 540 has a Qwerty keyboard 544 thereon. When the body 530 is pivotably mounted on the sliding member 540 about a pivot axle 502 and lengthwise aligned therewith, an upper portion of the sliding member 540 is hidden below the body 530, while a lower portion of the sliding member 540 is exposed, as shown in FIG. 16B. At this position, the handheld electronic device is mainly used as a mobile phone, and the keys at the exposed lower portion can be used as a standard mobile phone keypad 548 for entering telephone number or other telephone operations. When the sliding member 540 is rotated relative to the body 530 about the pivot axle 502 to reach the position of FIG. 16C, the Qwerty keyboard 544 is located relative to the body in a manner like that of the embodiment of FIG. 14B so that a user can easily use the Qwerty keyboard 544 for typing work. At this position, the handheld electronic device is mainly used as an e-mail machine.

FIG. 16D shows a variation of the ninth embodiment of the present invention. In order to reinforce the connection between the body 550 and the sliding member 560, the body 550 is integrally formed with a base 552 supporting the sliding member 560 so that a reliable connection between the body 550 and the sliding member 560 can be always-ensured. The body 550 defines a cavity 554 for receiving an upper portion of the sliding member 560 therein when the sliding member 560 is at the closed position, as shown in FIG. 16D.

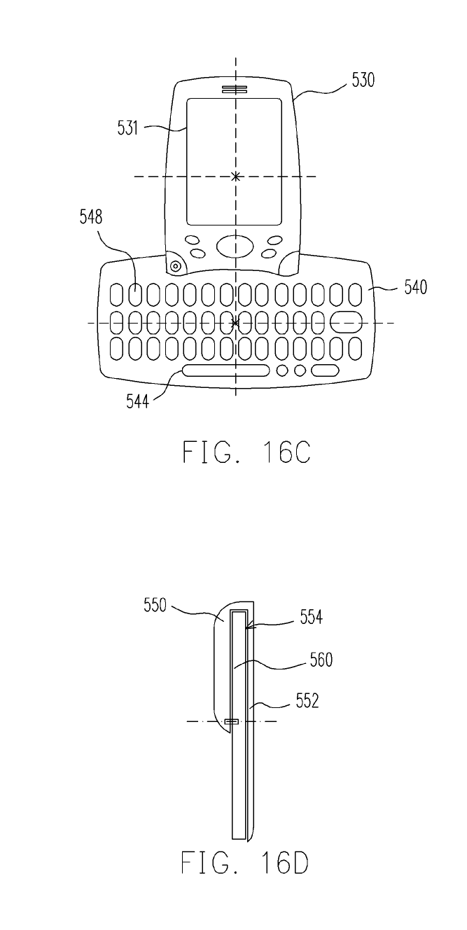

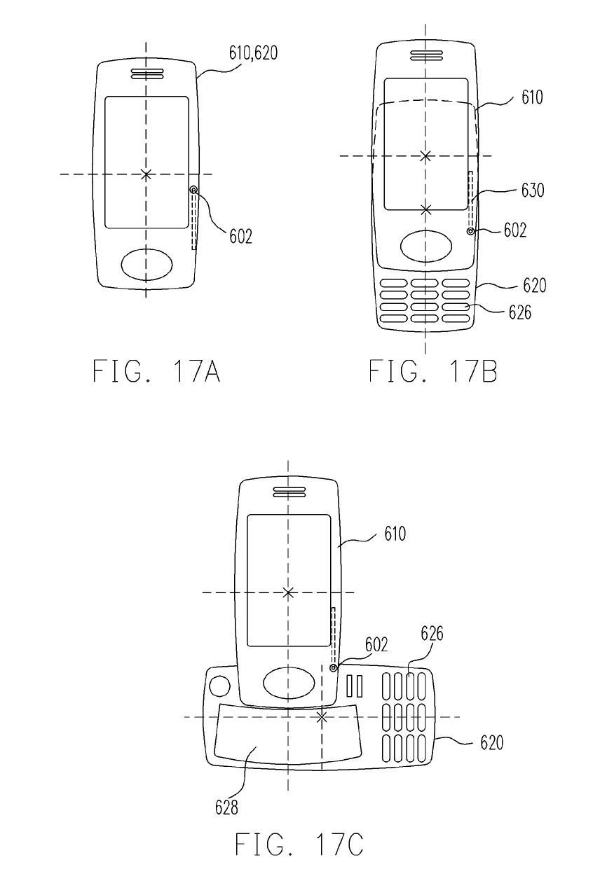

Referring to FIGS. 17A, 17B, and 17C, a handheld electronic device in accordance with a tenth embodiment of the present invention is shown. In this embodiment, the body 610 and the sliding member 620 have the same size and shape; thus, when the body 610 is pivotably mounted on the sliding member 620 about the pivot 602, the sliding member 620 is hidden below the body 610. The body 610 is provided with a groove 630 along which the pivot axle 602 can move therein. Therefore, unlike the embodiment of FIGS. 14A and 14B, in this embodiment, the sliding member 620 can move vertically downwardly relative to the body 610 before the sliding member 620 is rotated relative to the body 610. After the sliding member 620 is moved downwardly relative to the body 610 to reach the position of FIG. 17B, twelve keys 626 on the sliding member 620 are exposed and a user can use the keys as a mobile phone keypad. At the position of the FIG. 17B, the handheld electronic device is mainly used as a mobile phone. After the sliding member 620 is rotated relative to the body 610, a touch pad 628 on the sliding member 620 is shown so that a user can easily use the handheld electronic device to edit e-mail or other works needing text input by using the touch pad.

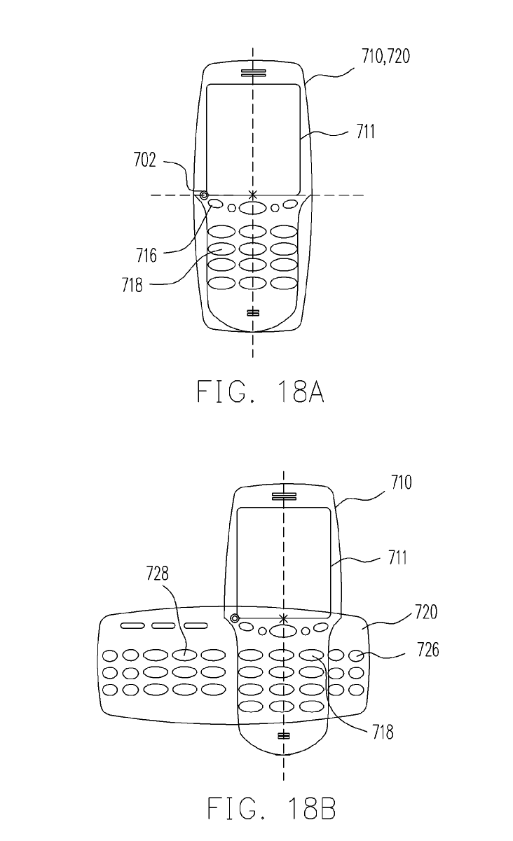

Referring to FIGS. 18A and 18B, a handheld electronic device in accordance with an eleventh embodiment of the present invention is illustrated. In this embodiment, the body 710 is provided with an LCD display 711, five operating buttons 716 below the LCD display 711, and a mobile phone keypad 718 under the operating buttons 716. The body 710 and the sliding member 720 are pivotably connected together at a pivot axle 702. When the body 710 and the sliding member 720 are lengthwise aligned, the handheld electronic device is used as a mobile phone. The pivot axle 702 so connects the sliding member 720 and the body 710 that when the sliding member 720 rotates relative to the body 710 for 90 degrees, the sliding member 720 extends across a lower end of the body 710 to cause the handheld electronic device to have a cross configuration (FIG. 18B). In this configuration, the keys on the mobile phone keypad 718 cooperate with keys 726 on the sliding member to form a Qwerty keyboard 728 so that a user can easily use the handheld electronic device to enter an e-mail or edit a text.

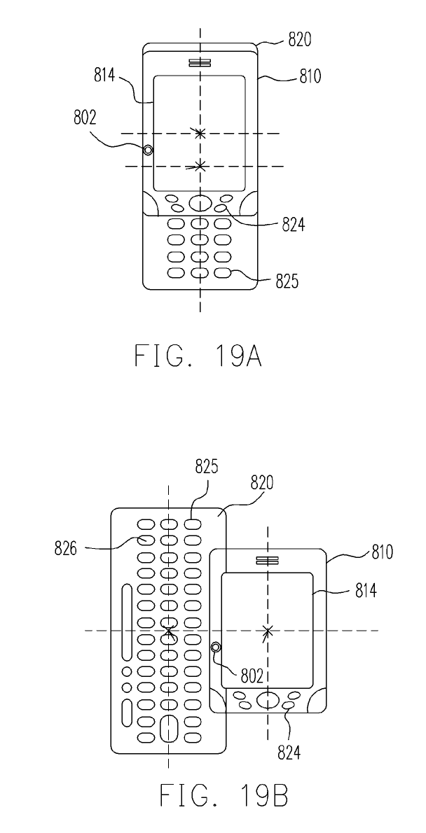

Referring to FIGS. 19A and 19B, a practical application of the handheld electronic device of the fifth embodiment of FIGS. 10A˜11B as a wireless PDA phone is shown. The body 810 includes a display 814 and five operating buttons 824 under the display 814. The sliding member 820 is provided with a Qwerty keyboard 826 thereon. The body 810 has a length shorter than that of the sliding member 820. The body 810 is pivotably mounted on the sliding member 820 about the pivot axle 802. When the body 810 is lengthwise aligned with the sliding member 820, twelve keys 825 of the Qwerty keyboard 826 are exposed for use as a mobile phone keypad. In this position (FIG. 19A) the handheld electronic device is used as a mobile phone. After the sliding member 820 is rotated 180 degrees clockwise relative to the body 810, the sliding member 820 is juxtaposed at a left side of the body 820 with upper and lower end portions of the keyboard 826 located above and below upper and lower ends of the body 810, respectively. At this position (FIG. 19B), the handheld electronic device is mainly used as an e-mail/Internet machine for reading, editing and sending e-mails and Internet browsing. In practical use, the handheld electronic device of FIG. 19B should be rotated 90 degrees counterclockwise therefrom so that the landscape display 814 is located above the Qwerty keyboard 826.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A handheld electronic device, having a geometric center line, comprising:
a body having a display; and
a sliding member pivotally connecting to a bottom of the first body via a pivot connection, wherein the pivot connection is off of the geometric center line for a distance, the sliding member has a keyboard, the sliding member moves between a first position and a second position relative to the body, where at the first position, the keyboard of the sliding member has at least a portion being hidden below the body, and where at the second position, ends of the sliding member protrude out of lateral sides of the body, respectively.

2. The handheld electronic device as recited in claim 1, wherein the sliding member rotates from the first position by 90 degrees to the second position.

3. The handheld electronic device as recited in claim 2 further comprising a guiding structure to guide the sliding member moving between the first position and the second position.

4. The handheld electronic device as recited in claim 3, wherein the guiding structure comprises an engaging member and an arched track wherein the engaging member is movably fitted in the track.

5. The handheld electronic device as recited in claim 1, wherein the second body rotates from the first position by 180 degrees to the second position.

6. The handheld electronic device as recited in claim 5 further comprising a guiding structure to guide the sliding member moving between the first position and the second position.

7. The handheld electronic device as recited in claim 6, wherein the guiding structure comprises an engaging member on the sliding member, the engaging member movably fitting in an arched track defined in the bottom of the body.

8. The handheld electronic device as recited in claim 7, wherein the arched track has a configuration of a semicircle.

9. The handheld electronic device as recited in claim 1, wherein the sliding member is moved from the first position to the second position by firstly movingly linearly and then rotatably relative to the body.

10. The handheld electronic device as recited in claim 1, wherein the sliding member is moved from the first position to the second position by firstly moving rotatably and then linearly relative to the body.

11. The handheld electronic device as recited in claim 1, wherein at the first position, the keyboard on the sliding member has some keys which are exposed under the display.

12. The handheld electronic device as recited in claim 11, wherein the body has operating buttons under the display, and at the first position, the operating buttons are located between the exposed keys of the keyboard of the sliding member and the display.

13. The handheld electronic device as recited in claim 12, wherein the body is integrally formed with a base, and the sliding member is supported by the base.

14. The handheld electronic device as recited in claim 1, wherein the body further comprises a plurality of keys under the display, and at the second position, the keys on the body cooperate with the keyboard of the sliding member to form a Qwerty keyboard.

15. A handheld electronic device, comprising:
a body;
a sliding member pivotably connected to the body, the sliding member having a keyboard thereon, and movable between a first position and a second position, wherein at the second position, the sliding member having two ends protruding out of two sides of the body, respectively.

16. The handheld electronic device as recited in claim 15, wherein at the second position, the handheld electronic device has a T-shaped configuration.

17. The handheld electronic device as recited in claim 15, where at the second position, the handheld device has a cross-shaped configuration.

18. A handheld electronic device, comprising:
a body having a display thereon;
a sliding member pivotably mounted to the body and moveable between first and second positions, at the first position, the sliding member being aligned with the body, at the second position, the sliding member having two ends located outside of two sides of the body, respectively.

19. The handheld electronic device as recited in claim 18, wherein the sliding member rotates 90 degrees to move from the first position to the second position.

20. The handheld electronic device as recited in claim 19 further comprising guiding means for guiding the sliding member to have a reliable and stable movement between the first and second positions.

21. The handheld electronic device as recited in claim 18, wherein the sliding member rotates 180 degrees to move from the first position to the second position.

22. The handheld electronic device as recited in claim 21 further comprising guiding means for guiding the sliding member to have a reliable and stable movement between the first and second positions.

23. The handheld electronic device as recited in claim 18, wherein the sliding member is provided with a keyboard thereon.

24. The handheld electronic device as recited in claim 18, wherein the sliding member is provided with a touch pad thereon.
